(19) United States
(12) Patent Application Publication
(10) Pub. No.: US 2009/0196119 A1
(43) Pub. Date: Aug. 6, 2009

(54) Containing device for containing and holding in a removable manner a closed container for fluid products inside a mixing machine

(75) Inventors: Guido Greco, San Felice Sul Panaro (MO) (IT); Gianfranco Beltrami, Stradella (PV) (IT)

Correspondence Address: HAMRE, SCHUMANN, MUELLER & LARSON, P.C., P.O. BOX 2902, MINNEAPOLIS, MN, 55402-0902, US

(73) Assignee: CPS COLOR EQUIPMENT SPA CON UNICO, San Felice S;ul Panaro (IT)

(21) Appl. No.: 11/630,615

(22) PCT Filed: Jun. 30, 2005
(86) PCT No.: PCT/IB05/01859

§ 371 Date: Dec. 22, 2006

(30) Foreign Application Priority Data
Jul. 1, 2004 (IT) UD2004A000138

(51) Int. Cl. B01F 15/00; B25J 15/00; B25B 1/24

(52) U.S. Cl. 366/209

(57) ABSTRACT

Containing device for containing and correctly holding closed container (11) for fluid products inside a mixing machine (12) for said fluid products. The containing device comprises a container element (13) provided with at least a lateral wall (14) that define a compartment (24), which is open and accessible from above, has a longitudinal axis (X) in the center and in which the container (11) is able to be disposed with play. Radial pressure elements (15) are disposed on substantially opposite sides with respect to the longitudinal axis (X) and are moveable in synchrony in order to selectively clamp the container (11) in a central position inside the compartment (24).

### FIELD OF THE INVENTION

The present invention concerns a containing device able to be used in a mixing machine in order to contain and hold correctly, inside the latter, a closed container, such as a can, a tin, a drum, a barrel or suchlike, containing one or more fluid products to be mixed together, such as for example coloring liquids, bases for paints, paints, enamels, inks and suchlike. To be more exact, the containing device according to the present invention comprises a frame, open at the upper part, into which a container to be mixed is able to be inserted with play. The frame is provided with a clamping mechanism, able to be selectively actuated in order to clamp the container, in a central position, adapting to the dimensions of the latter.

### BACKGROUND OF THE INVENTION

Containing devices are known, used to contain and hold a closed container of fluid products inside a mixing machine for such products, the latter also called mixer.

Known containing devices generally consist of a frame with a circular base, open at the upper part and able to be associated with mixing means of the mixing machine, occasionally of a different geometry, for example quadrangular. Known frames normally have sizes corresponding to those of the containers they have to contain, and are provided inside with adapting and clamping elements, in order to hold each container in the corresponding frame during the mixing cycle.

Clamping devices are also known which are able to press the container axially between a supporting plate and a pressure plate, in order to prevent the container from escaping from the mixing mechanism while it is functioning.

In practice, this axial pressure entails the danger that the container itself may be crushed, or damaged, with consequent possible leakages of the fluid product.

A mixing device is also known, from the U.S. Pat. No. 3,128,082, suitable to contain only containers substantially having a determinate diameter and comprising a containing frame consisting of a horizontal base, from which a plurality of elastic fingers depart vertically, which define, when inactive, a containing compartment with a lesser diameter than that of the containers to be inserted. Each container is inserted from above, and thrust downwards, bringing it into contact with the elastic fingers of the frame and forcing them outwards, opening them. This conventional device, due to the elasticity of the elastic fingers, does not guarantee optimum clamping and does not prevent the container from escaping during the mixing step.

A containing device is also known for containers having substantially the shape of a parallelepiped, wherein the frame also has the shape of a parallelepiped, open at the upper part, and wherein two clamping elements are provided disposed on two vertical adjacent walls, in order to clamp the container, which has two hollows on two of its corresponding lateral walls. This conventional device has the disadvantage that it can be used only for specific containers, provided with the above-mentioned hollows on the lateral walls.

Moreover, both said conventional containing devices are able to contain and clamp only containers with determinate lateral sizes, coherent with that of the containing frame, and it is therefore necessary to replace the frame every time a different frame from the one used before is used.

It is also known to use adapters or modified clamping elements, so that a single, large-size frame can contain and hold different containers. However, such adapters allow the frame to contain only containers of not too different sizes, and therefore it is always necessary, although this need is reduced, to replace the frame.

Moreover, using such adapters or modified clamping elements also entails an increase in the production costs, greater difficulty in using the containing device for the user and a reduction in the security of the clamping.

One purpose of the present invention is to achieve a containing device that will allow to contain and securely hold a wide range of containers for fluid products, without needing to replace it and without the aid of any adapter or modified element.

Another purpose of the present invention is to achieve a containing device to be inserted in a mixing mechanism that does not necessarily require the presence in the latter of a mechanism to grip the container axially, irrespective of the type and the characteristics of the mixing movement generated and necessary to obtain the mixing, whether it be of the rotational, oscillatory, elliptic, orbital type, or any combination thereof.

Another purpose of the present invention is to achieve a containing device that does not damage the container due to the action exerted by its clamping elements during the mixing steps.

The Applicant has devised, tested and embodied this invention to overcome the shortcomings of the state of the art and to obtain these and other purposes and advantages.

### SUMMARY OF THE INVENTION

The present invention is set forth and characterized in the main claim, while the dependent claims describe other characteristics of the invention or variants to the main inventive idea.

In accordance with the above purposes, a containing device according to the present invention is able to contain and hold in a removable manner a closed container containing fluid products, inside a mixing machine for said fluid products.

The containing device according to the invention comprises a containing element provided with at least a lateral wall that defines a compartment, which is open and accessible from above, has a longitudinal axis (X) at the center, and in which the container is able to be disposed, and clamping means able to selectively clamp the container inside the compartment.

According to a characteristic feature of the present invention, the clamping means comprise at least two radial pressure elements disposed at least partly inside the compartment and on substantially opposite sides with respect to the longitudinal axis “X”, said radial pressure elements are movable in synchrony between an inactive position, near said lateral wall, to allow the container to be introduced with play inside the compartment, and a clamping position wherein the pressure elements contact the container and keep it clamped in a determinate central position, substantially coaxial with the longitudinal axis (X); stop means are provided in order to selectively keep the radial pressure elements, at least temporarily, in said clamping position.

The clamping elements can be: two in number and disposed on diametrically opposite sides with respect to the longitudinal axis X; three in number and disposed angularly distanced by 120° from each other; four in number and disposed angularly distanced by 90° from each other; or more, and disposed angularly equidistant from each other.

The containing device according to the present invention can thus clamp a container inside it, at least temporarily, adapting to the size of said container, since every pressure element moves against a lateral surface of the container itself, irrespective of the lateral sizes of the latter, until it is clamped inside the containing compartment. Advantageously, when this clamping position has been reached, the pressure elements exert a further pressure against the lateral surface of the container, so as to guarantee the stable positioning reached.

In this way, the device according to the present invention acts laterally against the container, without the risk of damaging or crushing it axially, as happens with many of the known devices.

In one form of embodiment of the present invention, the clamping means also comprise at least an axial clamping element, that is, parallel to the longitudinal axis X, disposed outside the container, and able to prevent any axial sliding of the container inside the compartment. In this way, the container introduced in the compartment is clamped both laterally and also axially.

Advantageously, the containing device according to the present invention also comprises a command element connected to the pressure elements, for example by means of a group of levers disposed pantograph-wise, and able to be actuated manually or electrically in order to move the latter simultaneously between the inactive and clamping positions.

Moreover, the containing device according to the present invention is advantageously made of light materials, such as aluminum, or plastic material, and has a reduced and compact structure, provided with reliefs and lighter zones so that its overall mass is very limited.

According to another embodiment, the containing device according to the present invention comprises one or more balancing masses, disposed in radial and/or axial positions, so as to be able to balance possible containers of asymmetrical shape and/or weight.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic exploded view of a mixing machine to which a containing device according to the present invention is applied;

FIG. 2 is a lateral view of the containing device in FIG. 1 in a first operating condition;

FIG. 3 is a lateral view, partly in section, of the containing device in FIG. 1, in a second operating condition;

FIG. 4 is a section view of an enlarged detail of the containing device in FIG. 2;

FIG. 5 is a section view of a second enlarged detail of the containing device in FIG. 2;

FIG. 6 is a section view of a first variant of the containing device in FIG. 2;

FIG. 7 is a section view of a second variant of the containing device in FIG. 2.

### DETAILED DESCRIPTION OF A PREFERENTIAL FORM OF EMBODIMENT

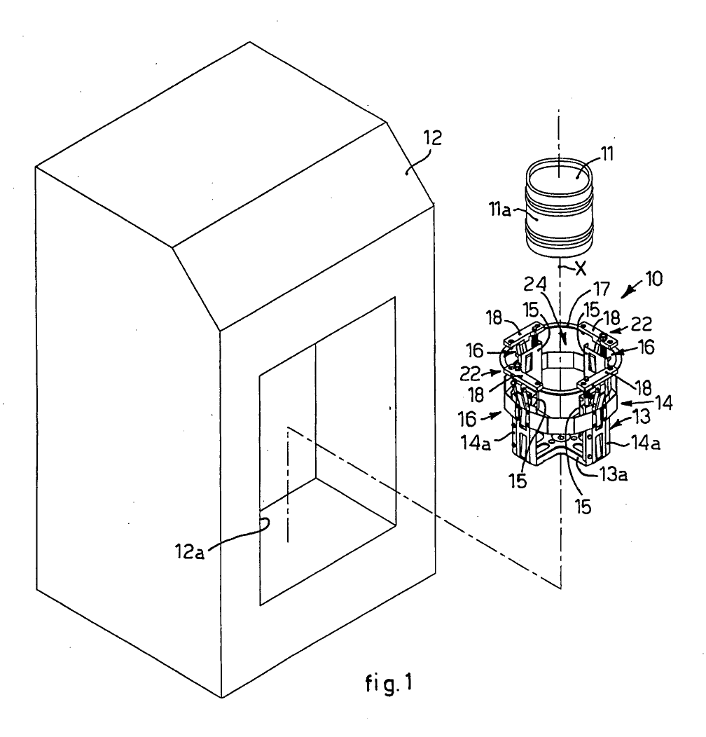

With reference to FIG. 1, a containing device 10 according to the present invention is able to contain and hold correctly, in a determinate central position, a closed container 11, inside a mixing chamber 12a of a mixing machine or mixer 12.

The container 11, in this case, is substantially cylindrical in shape and is able to contain one, two or more fluid products, such as for example dyes of different shades or colors, able to be stirred and/or mixed together and/or added to a base substance in order to make a paint of a determinate color, or other.

The mixing machine 12 can be of any known type, for example vibrational, rotational, either gyroscopic or orbital, or other type suitable to perform the mixing of the fluid products contained inside the container 11.

The containing device 10 comprises a metal frame 13, having a median longitudinal axis X and shaped so as to have a base 13a and a lateral wall 14 consisting in this case of four vertical arms 14a, disposed equidistant and offset angularly with respect to each other by about 90°. In this case, the four vertical arms 14a are made in a piece with the base 13a and are connected to each other, at the upper part, by a metal band 13b.

The lateral wall 14 defines, inside itself, a compartment 24 open and accessible from above, into which the container 11 is able to be introduced. The size of the compartment 24 is such as to contain, with play, a vast range of containers 11 having various shapes, diameters or lateral sizes, such as for example those that are found on the market.

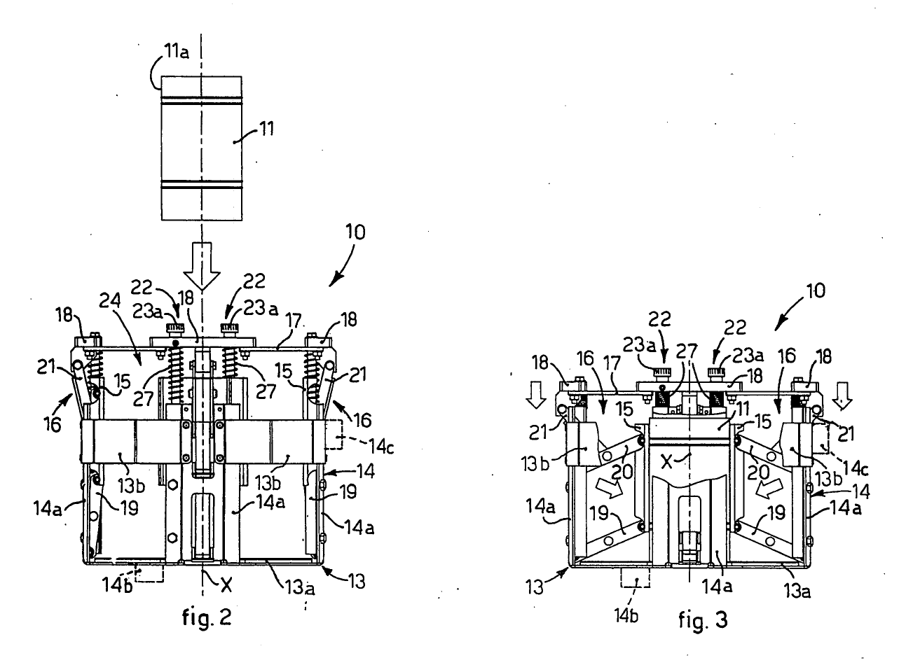

The metal frame 13 also comprises four radial pressure elements 15, which are associated with the four vertical arms 14a and are selectively movable between an inactive position (FIG. 2), substantially near the lateral wall 14, and a clamping position (FIG. 3), in which they contact the lateral surface 11a of the container 11 and keep it, at least temporarily, clamped inside the compartment 24, in a central position, substantially concentric with the longitudinal axis X of the frame. This also applies if the container 11 has been inserted into the frame 13 by chance, in any position offset with respect to the longitudinal axis X.

Each of the radial pressure elements 15 has a substantially flattened shape and is connected, by means of a respective group of levers 16, both to a corresponding vertical arm 14a and also to an annular element 17. The latter is disposed outside the metal frame 13 and is able to be actuated manually, or mechanically, in order to move the radial pressure elements 15 simultaneously by means of the respective groups of levers 16.

As shown by the lines of dashes in FIGS. 2 and 3, the metal frame 13 can optionally comprise one or more radial balancing masses 14b, and one or more axial balancing masses 14c, disposed for example but not necessarily, respectively on the bottom of the base 13a and in correspondence with a median zone of a vertical arm 14a. The masses 14b and 14c are able to allow a balanced rotation or oscillation of the containing device 10 when the container 11 contained therein has an asymmetrical shape and/or weight.

To be more exact, the annular element 17 comprises four gripping blocks 18, each one associated with a corresponding group of levers 16, so that the movement downwards of the gripping blocks 18 in practice entails the movement of the radial pressure elements 15 between the aforesaid inactive position (FIG. 2), and aforesaid clamping position (FIG. 3).

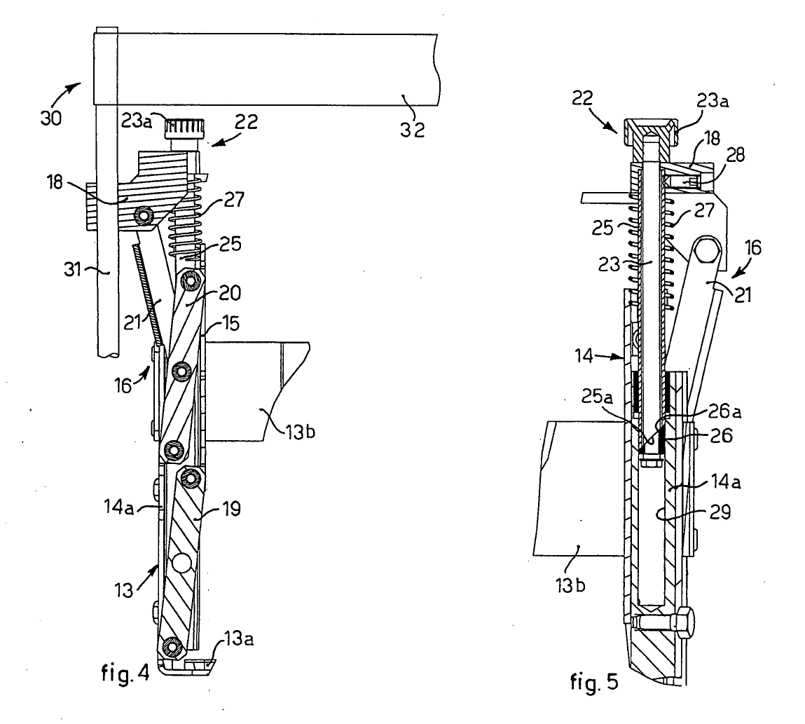

Each group of levers 16 (FIG. 4) comprises a first lever 19, a second lever 20 and a third lever 21.

The first lever 19 is pivoted with a first end to the corresponding vertical arm 14a, and with the other end is connected to a lower zone of the relative pressure element 15.

The second lever 20 is substantially parallel to the first lever 19, and is pivoted with one end to the corresponding vertical arm 14a and with the other end is connected to an upper zone of the relative pressure element 15.

The third lever 21 is pivoted with one end to a median segment of the second lever 20, and with the other end is connected to the corresponding gripping block 18 of the annular element 17.

In this way, by displacing downwards the corresponding gripping block 18 of the annular element 17, either manually or electrically, a linear force is generated by means of the third lever 21 in the median zone of the second lever 20. The linear force in turn generates a moment around the pivoting point of the second lever 20 with the corresponding vertical arm 14a.

The moment thus generated determines the movement of the radial pressure element 15 towards the longitudinal axis X of the compartment 24. The movement of the radial pressure element 15 is guided by the first lever 19, so that the front surface of the pressure element 15 remains substantially parallel to the relative vertical arm 14a during its movement.

The containing device 10 according to the present invention also comprises two stop devices 22 for the radial pressure elements 15, associated with corresponding opposite gripping blocks 18.

Each stop device 22 (FIG. 5) comprises a screw element 23, a tubular element 25, an internally threaded rod 26, and a helical spring 27.

The tubular element 25 is mounted by means of a headless screw 28 on the gripping block 18, and is disposed coaxial and sliding in a housing seating 29 made in the vertical arm 14a. Moreover, the tubular element 25 comprises an inclined lower surface 25a.

The screw element 23 is disposed through, both through the corresponding gripping block 18 and also through the tubular element 25, and is able to be screwed below the rod 26. Moreover, the screw element 23 comprises at the upper part a knob 23a which allows it to be screwed manually without tools.

The helical spring 27 is disposed coaxial outside the tubular element 25 between a lower surface of the gripping block 18 and an upper surface of the respective vertical arm 14a, in order to keep the two surfaces, lower and upper, normally distant from each other.

The rod 26 is disposed able to slide with play inside the housing seating 29, and has an inclined upper surface 26a, parallel with the lower surface 25a of the tubular element 25.

In this way, the screwing of the screw element 23 determines a sliding of the rod 26 inside the housing seating 29 until the two inclined surfaces 25a and 26a are reciprocally in contact. By continuing to screw the screw element 23, a reciprocal sliding is generated between the two inclined surfaces 25a and 26a, and hence a lateral movement of the rod 26 until it contacts under pressure an inner surface of the housing seating 29.

The contact under pressure determines, in turn, the reciprocal clamping of the annular element 17, with which the blocks 18 are indirectly associated, with respect to the corresponding vertical arms 14a, in which the housing seatings 29 are made.

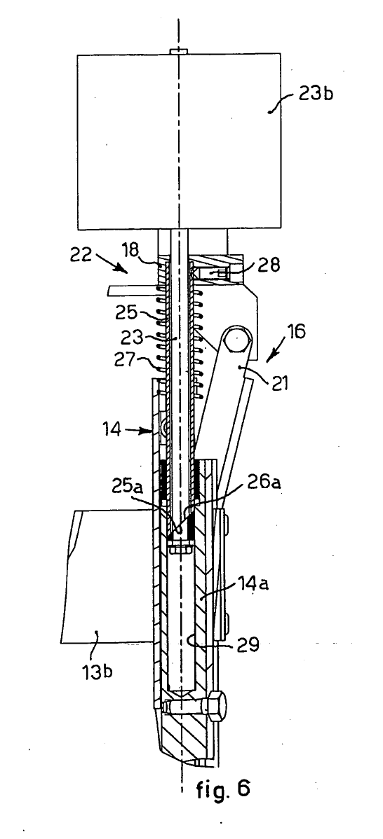

According to a first variant, shown in FIG. 6, the screw element 23, instead of the knob 23a, is driven by an electric motor 23b, connected to the gripping block 18.

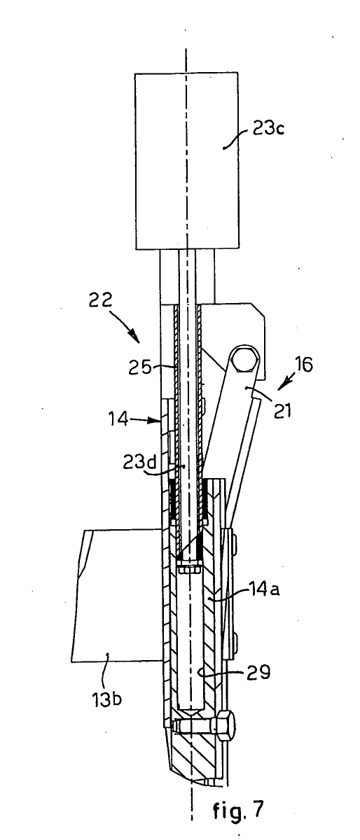

According to another variant, shown in FIG. 7, the screw element 23, instead of the knob 23a, is driven by a linear actuator 23c provided with a cylindrical rod 23d. In this case the screw element 23, the tube 25, the block 18 and the inclined surfaces 25a and 26a are no longer necessary.

Moreover, the containing device 10 according to the present invention, in correspondence with every gripping block 18 (FIG. 4) optionally comprises an axial clamping element 30, comprising a sliding shaft 31 and a blade 32.

The sliding shaft 31 is disposed substantially vertical and is mounted through and rotatable on the gripping block 18, while the blade 32 is attached flag-manner to the upper part of the sliding shaft 31.

In this way, by rotating and displacing axially (either manually, mechanically or electrically) the sliding shafts 31, the blades 32 are positioned in contact with an upper surface of the container 11, in order to prevent the latter from making a possible axial movement due to the forces in play during the mixing cycle actuated by the mixing machine 12.

The containing device 10 as described heretofore functions as follows.

Once filled with the desired fluid products and hermetically closed, the container 11 is introduced from above inside the compartment 24 of the metal frame 13.

Then pressure is exerted on the gripping blocks 18, so as to compress the helical springs 27 and move the pressure elements 15 until they are in contact with the lateral surface 11a of the container 11. When this condition has been reached, more pressure is exerted, so that the pressure elements 15 reciprocally press against the surface 11a of the container 11, so as to keep it stably positioned coaxial to the longitudinal axis “X” and inside the compartment 24.

Subsequently, maintaining the pressure, the screw elements 23 are screwed, so as to clamp, as we have seen, the positioning thus reached.

In this step, the axial clamping elements 30, if provided, are also positioned, so as to ensure the correct axial positioning of the container 11 inside the compartment 24 during the mixing cycle.

In accordance with one form of embodiment, shown in FIG. 1, the containing device 10 is attached, by means of known attachment means, not shown in the drawings, on a corresponding mixing unit present inside the mixing chamber 12a of the mixer 12 in order to effect the mixing of the fluid products contained in the container 11. In this case, the container 11 is inserted inside the containing device 10 which is already in the mixer 12.

At the end of the mixing cycle, once the radial and axial unclamping operations have been performed, the container 11 is removed from the containing device 10 inside the mixer 12.

According to a variant, not shown in the drawings, the attachment means are such as to allow the containing device 10 to be selectively attachable or detachable (manually or electrically) and consequently able to be inserted into or removed from inside the mixing chamber 12a of the mixer 12. In this second case, the container 11 is inserted into the containing device 10, or removed therefrom, outside the mixing chamber 12a of the mixer 12. The containing device 10 and the associated container 11 are then disposed, in a known manner, inside the mixing machine 12 in order to effect the mixing of the fluid products.

The attachment means thus allow to eliminate traditional clamping or containing devices for the container 11 and to use the same containing device 10 for various containers 11 and for various types of mixing machines 12 (for example rotary, vibrating, orbital).

In any case, at the end of the mixing cycle, the container 11 is removed from the compartment 24 of the containing device 10.

This last operation is performed by unscrewing the screw elements 23 so that, due to the effect of the springs 23 that thrust the gripping blocks 18 upwards, the pressure elements 15 are distanced from the lateral surface 11a of the container 11, leaving the latter free.

It is clear that modifications and/or additions of parts may be made to the device 10 as described heretofore, without departing from the field and scope of the present invention, for example the manual movements described heretofore may be actuated electrically.

It is also clear that, although the present invention has been described with reference to specific examples, a person of skill in the art shall certainly be able to achieve many other equivalent forms of containing device for containing and holding in a removable manner a closed container for fluid products inside a mixing machine, having the characteristics as set forth in the claims and hence all coming within the field of protection defined thereby.

1. A containing device for containing and correctly holding a closed container for fluid products inside a mixing machine for said fluid products, said containing device comprising a container element provided with at least a lateral wall that defines a compartment, which is open and accessible from above, has a longitudinal axis (X) in the center and in which said container is able to be disposed, and clamping means able to selectively clamp said container inside said compartment, characterized in that wherein said clamping means comprise at least two radial pressure elements disposed at least partly inside said compartment and on substantially opposite sides with respect to said longitudinal axis (X), and in that wherein said radial pressure elements are movable in synchrony between an inactive position, near said lateral wall, in order to allow said container to be introduced with play inside said compartment, and a clamping position wherein said radial pressure elements contact said container and keep said container clamped in a determinate central position, substantially coaxial with said longitudinal axis (X), stop means being provided in order to selectively maintain said radial pressure elements at least temporarily in said clamping position.

2. A containing device as in claim 1, wherein said clamping means also comprise at least an axial clamping element disposed outside said container element and able to prevent said container from axially sliding inside said compartment and from escaping from said compartment.

3. A containing device as in claim 1, wherein said radial pressure elements are disposed substantially equidistant from said longitudinal axis (X) and angularly equidistant with respect to each other.

4. A containing device as in claim 1, further comprising a command element connected to said radial pressure elements, and able to move said radial pressure elements simultaneously between said inactive and clamping positions.

5. A containing device as in claim 4, wherein each of said radial pressure elements has a substantially plane shape and is moved by a corresponding movement mechanism.

6. A containing device as in claim 5, wherein said movement mechanism comprises a group of levers able to connect the corresponding radial pressure element both to a segment of said container element and also to said command element.

7. A containing device as in claim 6, wherein said group of levers comprises a first lever having a first end pivoted to said segment of said container element and the other end connected to a lower zone of the relative radial pressure element, a second lever substantially parallel to said first lever, and having a first end pivoted to said segment of said container element and the other end connected to an upper zone of the relative radial pressure element, and a third lever having a first end pivoted to a median segment of said second lever and the other end connected to said command element.

8. A containing device as in claim 1, wherein said container element comprises a substantially horizontal base, substantially cross-shaped, from which four vertical arms branch off in a single piece.

9. A containing device as in claim 1, wherein said clamping means comprise motor means able to automatically command said radial pressure elements or said axial clamping element.

10. A containing device as in claim 9, wherein said motor means comprise at least an electric motor.

11. A containing device as in claim 9, wherein said motor means comprise at least a linear actuator.

12. A containing device as in claim 1, wherein said stop means comprise a tubular element provided with an inclined lower surface, attached to said command element and disposed coaxial and sliding in a mating housing seating made in said container element, a threaded rod disposed sliding inside said housing seating and having an inclined upper surface parallel to said lower surface, and a screw element disposed through both through said command element and also through said tubular element, and able to be screwed below said threaded rod.

13. A containing device as in claim 12, wherein said stop means also comprise a helical spring disposed coaxial outside said tubular element between a lower surface of said command element and an upper surface of said container element, in order to keep said lower surface and said upper surface normally distanced from each other.

14. A containing device as in claim 2, wherein said axial clamping element comprises a sliding shaft disposed substantially vertical and mounted through and rotatable on said command element, and a blade disposed substantially horizontal and attached to the upper part of said sliding shaft.

15. A containing device as in claim 1, wherein attachment means are provided for a selective attachment to or detachment from a corresponding mixing unit present inside a mixing chamber of said mixing machine.

16. A containing device as in claim 1, further comprising one or more balancing masses, associated with said container element in order to cooperate radially or axially with said container element, so as to balance possible containers of asymmetric shape or weight.

17. A containing device as in claim 1, wherein said container element is made of light materials, and has a compact structure provided with reliefs and lighter zones so that its overall mass of said container element is very limited.
